(19) United States
(12) Patent Application Publication
(10) Pub. No.: US 2006/0018730 A1
(43) Pub. Date: Jan. 26, 2006

(54) Drywall fastener

(76) Inventor: Richard J. Ernst, San Diego, CA (US)

Correspondence Address: LISA SOLTIS;ILLINOIS TOOL WORKS INC., 3600 WEST LAKE AVENUE, GLENVIEW, IL, 60025, US

(21) Appl. No.: 11/148,158

(22) Filed: Jun. 8, 2005

Related U.S. Application Data
(63) Continuation-in-part of application No. 10/844,706, filed on May 12, 2004.
(63) Continuation-in-part of application No. 10/939,795, filed on Sep. 13, 2004.
(60) Provisional application No. 60/510,708, filed on Oct. 10, 2003.

(51) Int. Cl. F16B 13/04

(52) U.S. Cl. 411/31; 411/387.1

(57) ABSTRACT

A self drilling fastener for use in a friable material mounted on a member comprises an elongated body having an axis, an enlarged head having torque transmitting surfaces therein, a proximal portion, an intermediate portion, a distal portion, and a drilling tip generally opposite the enlarged head. The proximal portion has a threaded exterior having a root, a crest diameter, and a thread height. The intermediate portion has a threaded exterior having a root, a crest diameter substantially smaller than the crest diameter of the proximal portion, and a thread height substantially smaller than the thread height of the proximal portion. The distal portion has a threaded exterior with a root that tapers toward the drilling tip, a crest diameter substantially smaller than the crest diameter of the proximal portion, and a thread height substantially smaller than the thread height of the proximal portion.

This application is a continuation-in-part of U.S. patent application Ser. No. 10/939,795, filed on Sep. 13, 2004, and of U.S. patent application Ser. No. 10/844,706, filed on May 12, 2004, which claims priority to U.S. Provisional Application No. 60/510,708, filed on Oct. 10, 2003.

### BACKGROUND OF THE INVENTION

1. Field of the Invention

The present invention is directed to a drywall fastener for use in a friable material, including a self-drilling drywall fastener to be used in drywall mounted to a stud member or the like.

2. Description of the Related Art

Because drywall is a friable material, mounting articles thereto can be difficult. In the past, at least three methods have been used. For light weight articles, small plastic expansion anchors have been used. These expansion anchors have typically required three steps to install: first, a hole is drilled into the drywall; second, the drywall fastener insert is driven into the drilled hole; and finally, a threaded fastener is advanced into the drywall fastener, spreading the drywall fastener into engagement with the drywall. However, expansion anchors can typically hold light loads only.

For heavy duty applications, toggle bolts have been used. While toggle bolts have been effective, they are also generally expensive because they involve parts which must move relative to one another. Toggle bolts also have been known to be difficult to install.

Self-drilling anchors for mounting heavier loads also have been used. These self-drilling anchors typically are installed by drilling into the drywall with the drywall fastener itself. The drywall fastener also includes threading having a high thread height to provide a high pullout in the drywall. Examples of self-drilling anchors include the drywall fastener sold under the trademark E-Z ANCOR manufactured by ITW Buildex, and those disclosed in U.S. Pat. Nos. 4,601,625, 5,190,425, and 5,558,479, all of which are assigned to the assignee of this application.

Self-drilling anchors have proved effective for holding higher loads when installed in drywall alone. However, in most cases the drywall is mounted to wood support members, or studs, that are unseen by the user, and typically the location of these support members are unknown and unchecked by the user. When a user of a typical self-drilling fastener attempts to install the drywall fastener in drywall at a location of a support member, the drywall fastener is unable to drill into the support member, causing the drywall fastener to spin in place so that the drywall fastener's high threading strips out the drywall, resulting in failure of the drywall fastener and creating an unsightly scar on the wall. Even if the drywall fastener is able to drill into the support member slightly, the anchors have been known to tightly engage the support member and break due to torsion on the anchor.

To install hooks, holders, or the like in drywall, many consumers use ordinary wood screws. While these may appear to work initially, the threads are generally too closely spaced and too low to achieve adequate contact with the drywall. Most commonly, these types of screws tend to bore a hole in the drywall, rather than gripping the drywall, leading to poor holding ability. Unless the installer locates a stud behind the drywall in which to drive the screw, an unsatisfactory result usually follows. While the use of anchors as described above generally overcomes this problem, existing anchors are usually unable to penetrate and attach to a stud or other structure behind the drywall, and require the multi-step installation process, i.e., initially centering and driving the anchor and then driving the proper fastener into the anchor to hold the object to be mounted to the wall. In some cases, the process may require pre-drilling of a pilot hole for the anchor, adding yet another step to the process. Also, is important to utilize the proper screw or other fastener which properly fits and grips the anchor in order to obtain a secure installation. The provision of a suitable self-drilling drywall screw would greatly simplify this process.

What is needed is a self-drilling fastener for use in drywall that can be installed either in drywall, or in drywall and a support member, and is capable of handling a heavy load.

### BRIEF SUMMARY OF THE INVENTION

A novel self drilling drywall fastener is provided for use in a friable material mounted on support member. The self drilling drywall fastener comprises a thin, elongate body having an axis, an exterior thread having a root, a proximal end, and a drilling end opposite the proximal end; wherein the exterior thread and said root together provide sufficient structural support to said body to withstand a torsion force required for the drilling end to penetrate a substrate adjacent the friable material, the substrate having a hardness greater than the hardness of the friable material.

In one embodiment, the self drilling drywall fastener comprises the self drilling fastener including an elongated body having an axis, an axial bore adapted to receive an elongated fastener, a enlarged head having torque transmitting surfaces therein, a proximal portion, an intermediate portion, a distal portion, and a drilling tip generally opposite the flared end, wherein the proximal portion has a threaded exterior having a root, a crest diameter, and a thread height, the intermediate portion has a threaded exterior having a root, a crest diameter substantially smaller than the crest diameter of the proximal portion, and a thread height substantially smaller than the thread height of the proximal portion, and the distal portion has a threaded exterior with a root that tapers toward the drilling tip, a crest diameter substantially smaller than the crest diameter of the proximal portion, and a thread height substantially smaller than the thread height of the proximal portion.

A method is provided for installing a self drilling fastener in a friable material and a substrate adjacent thereto, the substrate having a hardness greater than the hardness of the friable material. The method comprises the steps of providing an anchor comprised of thin-walled, elongate body having an axis, an exterior thread having a root, a proximal end, and a drilling end opposite the proximal end; and applying a torsion force to said fastener to drive the drilling end through the friable material and into the substrate, wherein the exterior thread and said root together provide sufficient structural support to said body for said body to withstand such torsion force.

A method of making a self drilling drywall fastener is also provided having the steps of providing a mold having a cavity with an enlarged head, a proximal section, an intermediate section, a distal section, a second end generally opposite said head; said proximal section having interior threading with a root, a crest diameter, and a thread height; said intermediate section having interior threading with a root, a crest diameter substantially smaller than said crest diameter of said proximal section, and a thread height substantially smaller than said thread height of said proximal section; and said distal section having a root that tapers toward said second end, a crest diameter substantially smaller than said crest diameter of said proximal section, and a thread height substantially smaller than said thread height of said proximal section; feeding molten material into said cavity; setting said molten material to form said anchor; and removing said self drilling fastener from said mold.

These and other features and advantages are evident from the following description of the present invention, with reference to the accompanying drawings.

### BRIEF DESCRIPTION OF THE SEVERAL VIEWS OF THE DRAWINGS

FIG. 1 is a perspective view of a self drilling drywall fastener according to the present invention.

FIG. 2 is a side view of the self drilling drywall fastener of FIG. 1.

FIG. 3 is a side view of the self drilling drywall fastener, rotated 90° from the view of FIG. 2.

FIG. 4 is a top view of the self drilling drywall fastener.

FIG. 5 is a bottom view of the self drilling drywall fastener.

### DETAILED DESCRIPTION

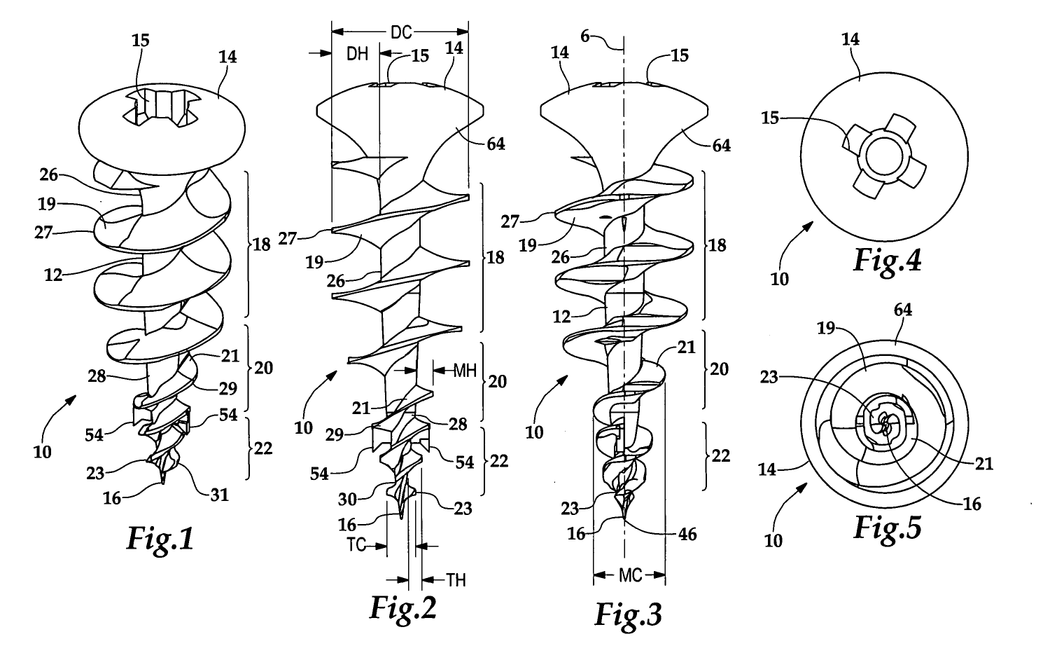

Referring to FIGS. 1-5, a novel self-drilling drywall fastener 10 is shown. Here, drywall fastener 10 is described in its general aspects and then, below, with respect to several exemplary embodiments, including the break-off tip embodiment shown in FIGS. 1-5.

Drywall fastener 10 is for use in a friable material, such as drywall, mounted on a member, such as a support member or stud, the novel drywall fastener 10 having an elongated body 12 with an axis 6, an enlarged head 14 having torque transmitting surfaces 15 therein, a proximal portion 18 proximate enlarged head 14, an intermediate portion 20, a distal portion 22, and a drilling tip 16 generally opposite enlarged head 14, wherein proximal portion 18 has a threaded exterior, such as drywall gripping threading 19, having a root 26, a crest 27 with a crest diameter DC, and a thread height DH, intermediate portion 20 has a threaded exterior, such as member gripping threading 21, having a root 28, a crest 29 with a crest diameter MC substantially smaller than drywall gripping threading crest diameter DC, and a thread height MH substantially smaller than drywall gripping thread height DH, and distal portion 22 has a threaded exterior, such as drilling threading 23, having a root 30 that tapers toward drilling tip 16, a crest 31 with a crest diameter TC substantially smaller than drywall gripping threading crest diameter DC, and a thread height TH substantially smaller than drywall gripping thread height DH.

Drywall fastener 10 is for driving into drywall for mounting an article to drywall. Drywall fastener 10 can be used in a manner similar to traditional fasteners when it is being installed in drywall. However, drywall fastener 10 includes features that allow drywall fastener 10 increase the amount of load that the friable material can withstand, and also allow drywall fastener 10 to penetrate and engage in a support member, such as a wood support stud, and that provide added strength to withstand the large forces of driving drywall fastener 10 into drywall and support member.

The friable material can be one of several friable materials used in construction wherein it is desired to mount an article to the friable material in order to increase the amount of load that the friable material can withstand. An example of the friable material is gypsum based drywall, such as the gypsum drywall sold under the trademark SHEETROCK by United States Gypsum. Drywall typically has a thickness T of ½ inch or ⅝ inch, but it can be obtained in other thicknesses, such as ⅜ inch.

Typically, friable materials such as drywall are mounted to a member, such as a wood structural support member, plywood, or another friable material, such as another layer of drywall. The member can be a support member, such as a wood support member, for example a 2×4 stud or the like, evenly spaced from other wood studs, e.g. every 16 inches, or a metal support member, such as a steel support stud. Support members are substantially more resistant to pullout than drywall because they are much less likely to break apart. Although drywall fastener 10 can be used on drywall mounted to another sheet of drywall, or other friable materials, the present invention will be described for use with support members such as a wood support stud.

Drywall fastener 10 can have different lengths to accommodate different thicknesses of article to be mounted to the drywall. Drywall fastener 10 is designed so that it can be used if the article is relatively thin or relatively thick, in which case drywall fastener 10 may have a greater length to achieve full engagement with the drywall. Ideally, the length of drywall fastener 10 is selected to limit the depth of embedment in the stud or other support member, thereby reducing the associated installation torque, and drive time, so that a user can install a plurality of drywall fasteners 10 in a relatively short period of time with a minimum of effort.

Distal Portion

Turning back to FIGS. 1-3, distal portion 22 allows drywall fastener 10 to drill through drywall and support member as it may be driven manually by a user so that a separate pre-drilling step is not needed. Distal portion 22 includes a drilling tip 16, and in one embodiment, shown in FIG. 2, drilling tip 16 is generally conical in shape and is coaxial with body 12 so that drilling tip 16 comes to point 46 at body axis 6. The drilling tip 16 includes a sharp point 46 to quickly engage and penetrate the surface of the drywall and the front surface of the stud or support member.

Distal portion 22 includes a threaded exterior having drilling threading 23 disposed on distal portion 22 for engaging drywall and support member. Drilling threading 23 includes a root 30 and a crest 31 having a crest diameter TC substantially smaller than drywall gripping threading crest diameter DC, and a thread height TH substantially smaller than drywall gripping thread height DH. Drilling thread height TH is also small enough so that the installation torque into the support member may be achieved manually by the typical user so that drywall fastener 10 can be driven into the support member. Threading 23 can also include a radius of curvature between the base of the thread 23 and root 30, to prevent the formation of stress concentrations at base of thread 23.

Continuing with FIGS. 2 and 3, drilling threading root 30 tapers from intermediate portion 20 toward drilling tip 16 so that the cross sectional area of drilling threading root 30 proximate drilling tip 16 is reduced with respect to the cross sectional area at intermediate portion 20. Thread height TH of drilling threading 23 remains substantially constant along the length of distal portion 22. However, because root 30 is relatively small, particularly at drilling tip 16, thread height TH can be larger, for example larger than thread height MH of member gripping threading 21, because the small root 30 allows a larger thread height without an overly large crest diameter TC.

Distal portion threading 23 and intermediate portion threading 21 engage drywall and drive drywall fastener 10 through drywal. If drywall fastener 10 is driven into a location wherein a support member is located behind drywall, drilling tip 16 hits support member, and if support member is relatively hard with respect to drywall , e.g. a wood support stud, then drywall fastener 10 typically spins within drywall without axially advancing into support member 10, referred to herein as stalling. As drywall fastener 10 stalls, distal portion threading 23 and intermediate portion threading 21 drill a hole of a predetermined size in drywall while drilling tip 16 drills into support member. Eventually drilling tip 16 drills to a depth into support member, usually between about ⅛ inch and about ¼ inch, that allows distal portion threading 23 to engage support member and begin pulling drywall fastener 10 through support member and drywall so that drywall gripping threading 19 can engage drywall.

It has been found that the size of the hole drilled into drywall by intermediate portion threading 21 is important in the grip created between drywall and drywall gripping threading 19, particularly if drywall fastener 10 is driven into drywall only. It has been found that for drywall threading having a crest diameter of about ½ inch, it is ideal for the hole drilled in the drywall to have a diameter of about ¼ inch. Therefore, distal portion 22 is designed to drill out a hole in drywall that generally maximizes to the extent practically attainable the pullout strength of drywall fastener 10 in drywall.

Continuing with FIG. 2, distal portion 22 can include at least one wing 54 that protrudes radially outwardly from distal portion 22 to ream out drywall to form a hole having a predetermined diameter selected to maximize pullout strength in drywall, particularly when drywall fastener 10 is driven into drywall only, with no support member behind the installation location. The wing 54 may extend to a distance from axis 6 that is approximately equal to the root radius of proximal portion 18 near head 14, wherein the root radius is half of the root diameter. Wings 54 are designed to break away when they hit support member so that wings 54 do not ream out support member, but only ream out drywall.

In the embodiment shown in FIG. 2, distal portion 22 includes a pair of wings 54 that protrude radially outwardly from distal portion 22. Wings 54 are evenly spaced around the perimeter of distal portion 22 so each of a pair of wings 54 are about 180° apart. Wings 54 protrude radially outwardly so that a width across wings 54 is approximately equal to root diameter of proximal portion 18 near head 14. If the hole reamed out by wings 54 be approximately equal to root diameter, the wings 54 ream out only as much drywall as is necessary, leaving behind a maximum amount of drywall for engagement with drywall gripping threading 19.

If, when drilling tip 16 hits support member, there is a momentary stall as drilling tip 16 drills into support member, as described above, the threading on drywall fastener 10 may begin to strip away a portion of the drywall. For this reason, it is important that drilling threading 23 engage support member and that distal portion 22 drill into support member quickly so that drywall fastener 10 does not excessively strip out drywall before being driven forward. Drilling threading 23 extends to an axial position that is as close to drilling tip 16 as possible so that drilling threading 23 can more quickly engage with support member. In one embodiment, drilling threading 23 extends substantially to said drilling tip 16 so that a lead of drilling threading 23, is axially spaced from drill tip point 46 by between about 0 inches, wherein drilling threading 23 extends substantially all the way to drilling tip 16, and about 0.06 inch. Ideally, the drilling threading 23 extends all the way to drilling tip 16, i.e. no space between tip point 46 and lead, however, it has been found that for a drilling tip that comes to a point, wherein the root essentially has a diameter of 0 inches, the drilling threading actually becomes axial, which can make it difficult for the drilling threading to engage support member. For this reason, the lead of drilling threading 23 can be spaced slightly from drilling tip 16, e.g. at about 0.02 inch.

Continuing with FIGS. 1 and 2, external threading 23 of distal portion 22 can include two generally helical threads arranged in a double helix. The double helix configuration of threads provides added support around distal portion 22 to help prevent distal portion 22 from collapsing due to the torsional forces of driving drywall fastener 10 into support member. Double helix threads also provide balanced driving into support member and faster engagement of drilling tip 16 with support member. In addition, the double lead threads extend to an axial position proximate to drilling tip 16 so that drywall fastener 10 can quickly engage and drill into support member.

Each thread of the double helix may have substantially the same pitch so that one of the threads does not overtake the other. The second thread may be spaced axially from first thread by approximately half the pitch of threads, ′, i.e. about 0.1 inch for a pitch of about 0.2 inch, so that at every axial position along distal portion 22, there is a thread on either side providing structural support. The threads of double helix may have substantially the same thread height.

A first thread of the double helix may continue as a thread 21 on intermediate portion 20 while a second thread is only present on distal portion 22. Both threads can also continue in a double helix on intermediate portion 20 (not shown) to provide structural support for intermediate portion 20 as well as distal portion 22. If second thread is extended onto intermediate portion 20, it provides improved grip with the support member.

Intermediate Portion

Returning to FIGS. 2 and 3, member gripping threading 21 is disposed on intermediate portion 20 and includes a root 28 and a crest 29 having a crest diameter MC substantially smaller than drywall gripping threading crest diameter DC. In the embodiment shown in FIG. 2, root 28 of intermediate portion 20 may taper slightly toward distal portion 22 so that the torque required to install drywall fastener 10 will be minimized, particularly in wood support members, because it allows the root diameter and crest diameter MC of intermediate portion 20 to be smaller. In one embodiment, member gripping threading root 28 tapers at an angle of between about ½ degree and about 4 degrees, and in one embodiment, about 2¼ degreeS.

The largest crest diameter MC of intermediate portion 20 may be selected to maximize the gripping between drywall gripping threading 19 and drywall, particularly when drywall fastener 10 is to be installed in drywall only. For example, for a drywall fastener 10 to have a drywall gripping threading crest diameter DC of about ½ inch, it is desired that the largest member gripping crest diameter MC be about ¼ inch or smaller.

In contrast to drywall gripping threading 19, described below, member gripping threading 21 has a thread height MH that is substantially smaller than the thread height DH of drywall gripping threading 19. The crest diameter MC of intermediate portion 20 is also substantially smaller than the crest diameter DC of proximal portion 18 so that the required installation torque in a support member, such as a wood stud, is not excessive. The crest diameter MC and thread height MH of member gripping threading 21 may be selected so that it is small enough that it does not scar or tear drywall when drywall fastener 10 stalls when drilling into support member, described above, and so that member gripping threading 21 does not engage drywall during stalling, which could jack drywall away from support member.

Although larger thread heights MH, TH of intermediate portion 20 and distal portion 22 would result in higher pullout strength within support member, it would also greatly increase the torque required to drive drywall fastener 10 into wood or other support member materials, making it difficult for a user to install drywall fastener 10, particularly with a hand-driven screwdriver. Therefore, thread height MH, TH should be chosen to allow for an acceptable torque in the event that some part of the intermediate portion 20 is driven into support member.

In the embodiment shown in FIG. 1, threading 21 of intermediate portion 20 is one generally helical thread 21 and is a continuation of drilling thread and extends on to drywall engaging thread 19 (described below). External threading 21 of intermediate portion 20 can also be a double helix similar to the double helix shown in distal portion 22 to provide added structural support on intermediate portion 20. Intermediate threading 21 can also have a radius of curvature between the base of thread 21 and root 28 to prevent the formation of stress concentration along the base of thread 21.

The combined length of intermediate portion 20 and distal portion 22 is larger than the thickness of the drywall so that when drywall fastener 10 stalls before beginning to drill into support member, the larger crested threading 19 of proximal portion 18 (described below) is not engaged with drywall, which would tend to strip out the drywall. This length should also be long enough so that distal portion 22 completes its drilling of drywall before drywall gripping threading 19 begins to engage drywall, particularly when drywall fastener 10 is driven into drywall only. This is desirable because drilling into a material tends axially advance through the material substantially slower than driving through the material with threading. For example, drywall fastener 10 is driven axially through drywall by drywall gripping threading 19 much faster than drywall fastener 10 can drill into drywall. If the drilling step is not completed before drywall gripping threading 19 begins to engage drywall, it is likely that drywall gripping threading 19 will strip out drywall rather than drive drywall fastener 10 through it. Additionally, it is important to properly proportion the lengths of intermediate portion 20 and distal portion 22 to the installation torques required to drive drywall fastener 10, particularly into support member.

Proximal Position

Returning to FIGS. 1-4, proximal portion 18 includes an exterior thread for engagement with drywall when drywall fastener 10 is installed so that the load of an article (e.g., if the article is a hook or holder, the load to be suspended or supported by the hook or holder) to be held by the fastener will be supported by drywall, particularly if drywall fastener 10 is driven into drywall only. Drywall gripping threading 19 taps a mating thread in drywall so that an engagement between drywall gripping threading 19 and drywall is accomplished. The threaded exterior includes threading 19 disposed on proximal portion 18 having a crest 27 with a crest diameter DC and a root 26. Drywall gripping threading 19 is high threading wherein the distance between crest 27 and root 26, or the thread height DH, is large relative to member gripping threading 21 and drilling threading 23. High drywall gripping threading 19 helps to maximize the surface area of drywall gripping threading 19 encountered by drywall, increasing the pullout strength. The thread height DH of drywall gripping threading 19 is substantially larger than the thread heights MH, TH of member gripping threading 21 and drilling threading 23, which provides for higher pullout strength in drywall. The diameter DC of drywall gripping threading crest 27 can remain essentially the same along the entire length of proximal portion 18. In one embodiment, the diameter DC of crest 27 is at least twice the diameter of root 26.

Turning to FIG. 5, approximately ¾ of a turn of drywall gripping threading 19 may be engaged behind drywall so that drywall engaging threading engages the paper on the rear surface of drywall. Engaging paper on drywall rear surface is particularly desirable when driving drywall fastener 10 into drywall only, because it has been found that engagement with the paper provides a substantial portion of the grip between drywall fastener 10 and drywall. Drywall gripping threading 19 is not intended to be driven into support member because the high drywall gripping threading 19 would require a very high torque to drive drywall fastener 10 into support member.

Returning to FIGS. 2 and 3, the root 26 of proximal portion 18 can be tapered toward intermediate portion 2, and so that the diameter of root 26 at the top of proximal portion 18 is larger than the diameter of root 26 at the bottom of proximal portion 18. In the embodiment shown in FIG. 2, tapered root 26 of proximal portion 18 and tapered root 28 of intermediate portion 20 are generally continuous and taper at approximately the same angle.

In the embodiment shown in FIGS. 1-3, exterior threading 19 of proximal portion 18 is one thread 19 that is a continuation of member gripping thread 21, except that drywall gripping threading 19 has a substantially larger crest diameter DC and a substantially larger thread height DH than the crest diameter MC and thread height MH of intermediate portion 20. In one embodiment, crest diameter DC of proximal portion 18 is about twice the crest diameter MC of intermediate portion 20.

There may be a transition zone between intermediate portion 20 and proximal portion 18 wherein the crest diameter and thread height enlarge from member gripping thread 21 to drywall gripping thread 19. In one embodiment, the transition zone extends for about ¾ of a thread turn. Drywall gripping threading 19 is generally helical, as best shown in FIG. 1. Drywall gripping threading 19 can also be a double helix of two threads, as described above, wherein one of the threads of the double helix can be a fine thread having a substantially smaller thread height than the thread height DH of drywall gripping thread 19. This second thread would provide added strength to drywall fastener 10. Drywall gripping thread 19 can also include a radius of curvature between the base of the thread 19 and root 26 to minimize stress concentration at the base of drywall thread 19.

The length of proximal portion 18, including head 14, may be slightly larger than the thickness T of drywall, as shown in FIG. 4, so that there is a portion of drywall gripping threading 19 behind drywall rear surface to engage rear surface paper. The length DL of proximal portion 18 may be selected to balance the length of drywall gripping threading 19 engaging the paper on the rear surface of drywall with the torque required to drive that length of drywall gripping threading 19 into a support member, if drywall fastener 10 is driven into a location where a support member is located. In addition, it is desirable that drywall fastener 10 be usable with different thicknesses of drywall , so that a certain length of proximal portion 18 may allow threading 19 to engage rear surface paper in one thickness of drywall, but may be too short to engage rear surface paper in a thicker drywall, or conversely, proximal portion 18 may be too long so that too much of drywall gripping threading 19 must be driven into a support member for a thinner drywall, resulting in a higher required installation torque.

The pitch of drywall gripping threading 19 is chosen so that there is at least one full turn of drywall gripping threading 19 in drywall. This pitch (of drywall gripping threading 19) may be chosen so that between about 1¾ turns and about 2¼ turns, and ideally about 2 full turns of drywall gripping threading 19 may be embedded in drywall. In one embodiment, for drywall having a thickness of ½ inch or ⅝ inch, the pitch P of drywall gripping threading 19 is between about ⅛ inch and about 0.3 inch, and in one embodiment, about 0.2 inch. Preferably, the pitch of drywall gripping thread 19 is generally equal to the pitches of member gripping threading 21 and drilling thread 23. In one embodiment (not shown) the pitch of drywall gripping threading 19 proximate intermediate thread 20 has a larger pitch than the remaining thread 19 proximate enlarged head 14. When this larger pitched threading engages drywall, it pulls drywall fastener 10 into drywall relatively fast, helping to counteract any jacking that may tend to occur.

Head

Turning to FIGS. 1-4, a surface 64 on the underside of the enlarged head 14 of drywall fastener 10 has an enlarged outer diameter with respect to drywall gripping threading root 26 to allow head 14 to grip an article to be fastened on drywall front surface 48. In one embodiment, head 14 has a head diameter of between about 0.45 inch and about 0.6 inch, and in one embodiment, about 0.515 inch. The head 14 also includes torque transmitting surfaces 15 so that drywall fastener 10 can be rotated with a driver by the user. The head 14 can include a recess 15 for receiving the tip of a driver wherein recess 15 is configured with torque transmitting surfaces 15 for a particular kind of driver. Illustrated recess 15 is a Phillips-type recess for receiving the tip of a Phillips-type driver.

Method of Installation

The method by which a user installs an drywall fastener 10 in drywall comprises the steps of providing an elongated drywall fastener 10 having an axis 6, an enlarged head 14 having torque transmitting surfaces 15 therein, a drilling tip 16 generally opposite enlarged head 14, a proximal portion 18 proximate enlarged head 14, an intermediate portion 20, and a distal portion 22 extending to drilling tip 16, wherein the proximal portion 18 has a threaded exterior, with a crest diameter and a thread height, the intermediate portion has a threaded exterior, with a crest diameter substantially smaller than the proximal portion threading crest diameter, and a thread height substantially smaller than the proximal portion thread height, and the distal portion 22 has a threaded exterior with a crest diameter substantially smaller than the proximal portion threading crest diameter, and a thread height substantially smaller than the proximal portion thread height; positioning drilling tip 16 on drywall surface, and driving drywall fastener 10 into drywall so that the distal portion 22 drills through drywall and into any stud or other support member present, and the drywall gripping threading 19 engages a major portion of the thickness of the drywall.

Method of Making

A method of making a drywall fastener 10 comprises the steps of providing a mold having a cavity which has the same shape as drywall fastener 10 so that when the material sets, drywall fastener 10 is formed; feeding molten material, such as a zinc alloy, into the mold cavity, setting the molten material to form a drywall fastener, and removing the drywall fastener from the mold.

The novel drywall fastener of the present invention allows a user to install the drywall fastener in drywall without being concerned about whether or not a stud member is located behind the drywall at the drywall fastening location or, as may be the case, when it is known that there is a stud member present.

While the foregoing written description of the invention enables one of ordinary skill to make and use what is considered presently to be the best mode thereof, those of ordinary skill will understand and appreciate the existence of variations, combinations, and equivalents of the specific exemplary embodiment and method herein. The invention should therefore not be limited by the above described embodiment and method, but by all embodiments and methods within the scope and spirit of the invention as claimed.

What is claimed is:

1. A self drilling fastener for use in a friable material mounted on a member, comprising:
an elongated body having an axis, an enlarged head having torque transmitting surfaces therein, a proximal portion, an intermediate portion, a distal portion, and a drilling tip generally opposite said enlarged head;
said proximal portion having a threaded exterior having a root, a crest diameter, and a thread height;
said intermediate portion having a threaded exterior having a root, a crest diameter substantially smaller than said crest diameter of said proximal portion, and a thread height substantially smaller than said thread height of said proximal portion;
said distal portion having a threaded exterior with a root that tapers toward said drilling tip, a crest diameter substantially smaller than said crest diameter of said proximal portion, and a thread height substantially smaller than said thread height of said proximal portion.

2. A self drilling fastener according to claim 1, wherein said root of said intermediate portion tapers toward said distal portion.

3. A self drilling fastener according to claim 1, wherein said threaded exterior of said distal portion comprises a pair of threads each having a lead proximate said drilling tip.

4. A self drilling fastener according to claim 1, wherein said root of said proximal portion has a radius, said fastener further comprising at least one wing protruding radially from said distal portion to a distance from said axis approximately equal to said root radius.

5. A self drilling fastener according to claim 1, wherein said head further comprises a recess for receiving a driver.

6. A self drilling fastener according to claim 1, wherein said body is molded zinc alloy.

7. A self drilling fastener for use in a friable material mounted on a member, comprising:
an elongated body having an axis, an enlarged head having torque transmitting surfaces therein, a proximal portion, an intermediate portion, a distal portion, and a drilling tip generally opposite said head, wherein said intermediate portion tapers toward said distal portion, and said distal portion tapers toward said drilling tip;
wherein said body includes a first exterior thread disposed on said proximal portion, said intermediate portion, and said distal portion, wherein said first exterior thread has a lead proximate said drilling tip;
wherein said first exterior thread at said proximal portion has a crest diameter and a high thread height for gripping said friable material, said first exterior thread at said intermediate portion has a crest diameter substantially smaller than said crest diameter at said proximal portion and a thread height substantially smaller than said high thread height at said proximal portion, and said first exterior thread at said distal portion has a crest diameter substantially smaller than said crest diameter at said proximal portion and a thread height substantially smaller than said high thread height at said proximal portion, said first exterior thread having a transition zone between said high thread height at said proximal portion and said thread height at said intermediate portion.

8. A self drilling fastener according to claim 8, wherein said crest diameter at said proximal portion is approximately twice said crest diameter at said intermediate portion.

9. A self drilling fastener for use in a friable material mounted on a member, comprising:
an elongated body having an axis, an enlarged head having torque transmitting surfaces therein, a proximal portion, an intermediate portion, a distal portion, and a drilling tip extending to an original position generally opposite said head, wherein said intermediate portion tapers toward said distal portion at a generally constant first angle with respect to said axis, wherein said distal portion tapers toward said drilling tip at a generally constant second angle with respect to said axis, said second angle being larger than said first angle;
wherein said body includes a first exterior thread disposed on said proximal portion, said intermediate portion, and said distal portion, wherein said first exterior thread has a lead proximate said drilling tip;
wherein said first exterior thread at said proximal portion has a crest diameter and a high thread height, said first exterior thread at said intermediate portion has a crest diameter substantially smaller than said crest diameter at said proximal portion and a thread height substantially smaller than said high thread height at said proximal portion, and said first exterior thread at said distal portion has a crest diameter substantially smaller than said crest diameter at said proximal portion and a thread height substantially smaller than said high thread height at said proximal portion, said first exterior thread having a transition zone between said high thread height at said proximal portion and said thread height at said intermediate portion.

10. A self drilling fastener for use in a friable material mounted on a member, comprising:
an elongated body having an axis, an enlarged head having torque transmitting surfaces therein, a proximal portion, an intermediate portion having an outer diameter, a distal portion having and outer diameter, and a drilling tip extending to an original position generally opposite said head, wherein said intermediate portion tapers toward said distal portion, and said distal portion tapers toward said drilling tip;
wherein said body includes a first exterior thread disposed on said proximal portion, said intermediate portion, and said distal portion, wherein said first exterior thread has a lead proximate said drilling tip;
wherein said first exterior thread at said proximal portion has a crest diameter and a high thread height, said first exterior thread at said intermediate portion has a crest diameter substantially smaller than said crest diameter at said proximal portion and a thread height substantially smaller than said high thread height at said proximal portion, and said first exterior thread at said distal portion has a crest diameter substantially smaller than said crest diameter at said proximal portion and a thread height substantially smaller than said high thread height at said proximal portion, said first exterior thread having a transition zone between said high thread height at said proximal portion and said thread height at said intermediate portion.

11. A method of installing a self drilling fastener in a friable material mounted on a member, comprising the steps of:
providing a self drilling fastener having an axis, an enlarged head having torque transmitting surfaces therein, a proximal portion, an intermediate portion, a distal portion, and a drilling tip generally opposite said head;
said proximal portion having a threaded exterior with a root, a crest diameter, and a thread height;
said intermediate portion having a threaded exterior with a root, a crest diameter substantially smaller than said crest diameter of said proximal portion, and a thread height substantially smaller than said thread height of said proximal portion;
said distal portion having a threaded exterior with a root that tapers toward said drilling tip, a crest diameter substantially smaller than said crest diameter of said proximal portion, and a thread height substantially smaller than said thread height of said proximal portion; and
driving said self drilling fastener into said friable material so that said distal portion drills through said friable material and into said member, and said proximal portion threaded exterior engages said friable material.

12. A method of making a self drilling fastener, the method comprising the steps of:
providing a mold having a cavity with an enlarged head, a proximal section, an intermediate section, a distal section, a second end generally opposite said head; said proximal section having interior threading with a root, a crest diameter, and a thread height; said intermediate section having interior threading with a root, a crest diameter substantially smaller than said crest diameter of said proximal section, and a thread height substantially smaller than said thread height of said proximal section; and said distal section having a root that tapers toward said second end, a crest diameter substantially smaller than said crest diameter of said proximal section, and a thread height substantially smaller than said thread height of said proximal section;
feeding molten material into said cavity;
setting said molten material to form said anchor; and
removing said self drilling fastener from said mold.

13. A self drilling fastener for use in a friable material, comprising:
a thin, elongate body having an axis, an exterior thread having a root, a proximal end, and a drilling end opposite the proximal end;
wherein the exterior thread and said root together provide sufficient structural support to said body to withstand a torsion force required for the drilling end to penetrate a substrate adjacent the friable material, the substrate having a hardness greater than the hardness of the friable material.

14. The self drilling fastener according to claim 13, further comprising a drilling thread proximate the drilling end.

15. The self drilling fastener according to claim 13, said body further comprising a proximal portion adjacent the proximal end, a distal portion adjacent the drilling end, and an intermediate portion therebetween.

16. The self drilling fastener according to claim 13, wherein said body tapers from the proximal end to the drilling end.

17. The self drilling fastener according to claim 13, wherein the thread height of the exterior thread tapers from the proximal end to the drilling end.

18. The self drilling fastener according to claim 13, said body further comprising a proximal portion adjacent the proximal end and a distal portion adjacent the drilling end, wherein the thread height of the exterior thread on the proximal portion is greater than the thread height of the exterior thread on the distal portion.

19. The self drilling fastener according to claim 18, said body further comprising an intermediate portion between the proximal portion and the distal portion, wherein the thread height of the exterior thread on the intermediate portion is less than the thread height of the exterior thread on the proximal portion.

20. The self drilling fastener according to claim 13, said body further comprising a proximal portion adjacent the proximal end and a distal portion adjacent the drilling end, wherein the axial length of the distal portion is greater than the thickness of the friable material.

21. The self drilling fastener according to claim 13, said body further comprising a proximal portion adjacent the proximal end, a distal portion adjacent the drilling end, and an intermediate portion therebetween, wherein the axial length of the intermediate portion and the distal portion is greater than the thickness of the friable material.

22. The self drilling anchor according to claim 13, wherein a centering element is disposed on the drilling end.

23. The self drilling anchor according to claim 13, said body further comprising a distal portion adjacent the drilling end having at least one wing protruding radially outwardly from the distal portion.

24. The self drilling fastener according to claim 23, wherein the at least one wing is integral with a drilling thread on the distal portion.

25. The self drilling fastener according to claim 24, wherein the at least one wing protrudes downwardly and terminates in a pointed end.

26. A method for installing a self drilling fastener and in a friable material and a substrate adjacent thereto, the substrate having a hardness greater than the hardness of the friable material, comprising the steps of:
providing a self drilling fastener comprised of a thin, elongate body having an axis, an exterior thread having a root, a proximal end, and a drilling end opposite the proximal end; and
applying a torsion force to said fastener to drive the drilling end through the friable material and into the substrate, wherein the exterior thread and said root together provide sufficient structural support to said body for said body to withstand such torsion force.
